(19) United States
(12) Patent Application Publication
(10) Pub. No.: US 2025/0303570 A1
(43) Pub. Date: Oct. 2, 2025

(54) ROBOT CONTROL DEVICE

(71) Applicant: FANUC CORPORATION, Minamitsuru-gun, Yamanashi (JP)

(72) Inventor: Keisuke NAGANO, Minamitsuru-gun, Yamanashi (JP)

(21) Appl. No.: 18/867,269

(22) PCT Filed: Jun. 15, 2022
(86) PCT No.: PCT/JP2022/023969

§ 371 Date: Nov. 19, 2024

(51) Int. Cl. B25J 9/16

(52) U.S. Cl. CPC B25J 9/1674

(57) ABSTRACT

The objective of the present invention is to enable processing of another Ethernet port to be executed without interference resulting from interrupt processing of an Ethernet port in which Ethernet communication congestion has occurred. This robot control device can be connected to at least one appliance via Ethernet, and comprises a control unit and a plurality of Ethernet ports, the control unit comprising: a detecting unit for detecting a packet loss state in at least one Ethernet port among the plurality of Ethernet ports; and a transitioning unit which, if interrupt processing is performed with respect to a packet from the at least one Ethernet port among the plurality of Ethernet ports, and the packet loss exceeds a predetermined threshold, transitions the interrupt processing to polling processing.

### TECHNICAL FIELD

The present invention relates to a robot control device.

### BACKGROUND ART

Such a technique has been known that, when a teach pendant is operated, operation information is transmitted to a robot control device, and the operation information is processed in the robot control device. For example, see Patent Document 1.

Ethernet (registered trademark) communication is used between the teach pendant and the robot control device, in which data is divided in a data format called packet for transmission and reception. When Ethernet communication between the teach pendant and the robot control device is possible, it is possible to operate the teach pendant. When a teaching screen displayed on the teach pendant changes (transitions), for example, pieces of teaching screen information are sequentially transmitted from the teach pendant to the robot control device.

### CITATION LIST

### Patent Document

Patent Document 1: Japanese Unexamined Patent Application, Publication No. 2006-142480

### DISCLOSURE OF THE INVENTION

### Problems to be Solved by the Invention

By the way, the robot control device is provided with a plurality of Ethernet ports for establishing Ethernet communication with other appliances including the teach pendant, for example. In the robot control device, a single processor (for example, a central processing unit (CPU)) executes processing related to the plurality of Ethernet ports. Therefore, the processor has a function called interrupt processing, allowing the interrupt processing to stop processing executed so far and to execute processing that is high in degree of priority.

When Ethernet communication is congested, the processor may face difficulties in executing other processing when packets are received in a large amount and the interrupt processing is executed many times.

It has then been desired to make it possible to execute processing for another Ethernet port without interference resulting from interrupt processing for an Ethernet port in which Ethernet communication congestion has occurred.

### Means for Solving the Problems

An aspect of a robot control device according to the present disclosure is a robot control device that is couplable to at least one appliance based on Ethernet, the robot control device including: a control unit; and a plurality of Ethernet ports, in which the control unit includes: a detecting unit configured to detect a state of a loss of a packet in at least one Ethernet port among the plurality of Ethernet ports; and a transitioning unit configured to cause, when interrupt processing is executed with respect to a packet from at least one Ethernet port among the plurality of Ethernet ports, and a loss of a packet exceeds a threshold value that is set in advance, the interrupt processing to transition to polling processing.

### Effects of the Invention

According to the aspect, it is possible to execute processing for another Ethernet port without interference resulting from interrupt processing for an Ethernet port in which Ethernet communication congestion has occurred.

### BRIEF DESCRIPTION OF THE DRAWINGS

FIG. 1 is a view illustrating a functional block configuration of a robot control system according to an embodiment;

FIG. 2 is a view illustrating a functional block configuration of a teach pendant; and

FIG. 3 is a flowchart illustrating transition processing in the robot control device.

### PREFERRED MODE FOR CARRYING OUT THE INVENTION

A robot control device according to an embodiment will now be described herein with reference to the accompanying drawings.

### Embodiment

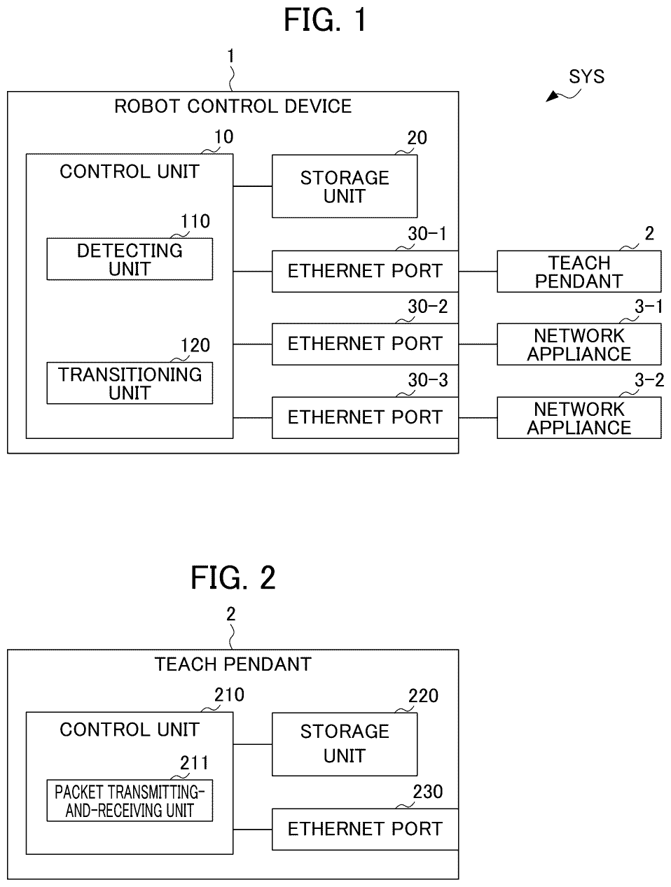

FIG. 1 is a view illustrating a functional block configuration of a robot control system according to an embodiment.

As Illustrated in FIG. 1, a robot control system Sys includes a robot control device 1, a teach pendant 2, and network appliances 3-1 to 3-2.

The robot control device 1, the teach pendant 2, and the network appliances 3-1 to 3-2 are coupled to each other via a network that is not shown such as a local area network (LAN) or the Internet to perform Ethernet communication. In this case, the robot control device 1, the teach pendant 2, and the network appliances 3-1 to 3-2 each include a communication unit that is not shown for performing Ethernet communication with each other through the coupling.

### <Teach Pendant 2>

The teach pendant 2 may be coupled to the robot control device 1, may allow a user to operate a robot that is not shown, and may calculate a robot program.

FIG. 2 is a view illustrating a functional block configuration of the teach pendant 2.

As illustrated in FIG. 2, the teach pendant 2 includes a control unit 210 and a storage unit 220. Furthermore, the control unit 210 includes a packet transmitting-and-receiving unit 211.

The storage unit 220 is, for example, a solid state drive (SSD) or a hard disk drive (HDD), and stores an operating system (OS) and various types of software.

An Ethernet port 230 is coupled to the robot control device 1 described later with a LAN cable, allowing signals for Ethernet communication to be transmitted and received between the control unit 210 and the robot control device 1.

The control unit 210 is one that is known among those skilled in the art, and includes a central processing unit (CPU), a read-only memory (ROM), a random access memory (RAM), and a complementary metal-oxide semiconductor (CMOS) memory, for example, which communicate with each other via a bus.

The CPU represents a processor that wholly controls the teach pendant 2. The CPU reads, via the bus, system programs and application programs stored in the ROM to wholly control the teach pendant 2 in accordance with the system programs and the application programs. Thereby, as illustrated in FIG. 2, the control unit 210 achieves a function of the packet transmitting-and-receiving unit 211. The RAM stores various types of data including temporal calculation data and display data. The CMOS memory is backed up by a battery that is not shown, and is used as a non-volatile memory that holds a stored state even when a power supply to the teach pendant 2 goes off.

The packet transmitting-and-receiving unit 211 generates, for performing Ethernet communication with the robot control device 1 described later, a packet storing data including operation information based on an Ethernet communication standard, transmits the generated packet to the robot control device 1, and allows the robot control device 1 to execute interrupt processing. Furthermore, the packet transmitting-and-receiving unit 211 receives a packet from the robot control device 1, and extracts data from the received packet.

Note that the packet transmitting-and-receiving unit 211 transmits, when a notification that the robot control device 1 described later executes polling processing is received, a packet to the robot control device 1 each time an inquiry for the polling processing is received from the robot control device 1.

### <Network Appliances 3-1 to 3-2>

The network appliances 3-1 to 3-2 are, for example, servers that collect data indicating operation states of the robot control device 1 and the robot that is not shown, and stores a robot program that the robot control device 1 executes and setting data.

Note that the network appliances 3-1 to 3-2 may each have a function that is similar to the function of the teach pendant 2 illustrated in FIG. 2.

### <Robot Control Device 1>

The robot control device 1 is a robot control device that is known among those skilled in the art, and may be directly coupled to the robot that is not shown via a coupling interface that is not shown. Furthermore, the robot control device 1 may be coupled to the robot that is not shown via a network that is not shown such as a local area network (LAN) or the Internet.

The robot control device 1 generates a command based on a robot program calculated using the teach pendant 2, for example, and transmits the generated command to the robot (not shown). Thereby, the robot control device 1 controls operation of the robot that is not shown.

As illustrated in FIG. 1, the robot control device 1 includes a control unit 10, a storage unit 20, and three Ethernet ports 30-1 to 30-3. Furthermore, the control unit 10 includes a detecting unit 110 and a transitioning unit 120.

The storage unit 20 is, for example, an SSD or an HDD, and stores an OS, various types of software, and various types of setting files.

The OS is, for example, an operating system (OS) or a system program executed in the robot control device 1.

Various types of software includes pieces of software including, for example, an operation program for the robot that is not shown and application programs for achieving various types of functions including control of a cache line for the robot control device 1.

Various types of setting files are, for example, setting files for pieces of software, which are stored in various types of software.

The Ethernet ports 30-1 to 30-3 are, as illustrated in FIG. 1, coupled to the teach pendant 2 and the network appliances 3-1 to 3-2, respectively, via LAN cables, and transmit and receive packets for Ethernet communication with the control unit 10, the teach pendant 2, and the network appliances 3-1 to 3-2, respectively.

Note that the Ethernet ports 30-1 to 30-3 will be hereinafter collectively referred to as the “Ethernet ports 30”, unless otherwise specifically distinguished from each other.

Furthermore, the robot control device 1 may include two ox more plurality of Ethernet ports 30 other than three.

The control unit 10 is one that is known among those skilled in the art, and includes a CPU, a ROM, a RAM, and a CMOS memory, for example, which communicate with each other via a bus.

The CPU represents a processor that wholly controls the robot control device 1. The CPU reads, via the bus, system programs and application programs stored in the ROM to wholly control the robot control device 1 in accordance with the system programs and the application programs. Thereby, as illustrated in FIG. 1, the control unit 10 achieves functions of the detecting unit 110 and the transitioning unit 120. The RAM stores various types of data including temporal calculation data and display data. The CMOS memory is backed up by a battery that is not shown, and is used as a non-volatile memory that holds a stored state even when a power supply to the robot control device 1 goes off.

Note that the CPU representing the processor in the robot control device executes, when packets equal to or greater than a predetermined amount that is set in advance are received from one of the Ethernet ports 30, the interrupt processing with respect to a packet from the one of the Ethernet ports 30.

The detecting unit 110 detects a state of a loss of a packet in at least one Ethernet port 30 among the Ethernet porta 30-1 to 30-3.

Specifically, the detecting unit 110 detects, for example, an amount of packets that are lost in a certain period of time (for example, 500 msec or 1 second) in each of the Ethernet ports 30. Note that, a loss of a packet may include a packet that could not be received from the teach pendant 2 or the network appliances 3-1 to 3-2.

The transitioning unit 120 causes, when the interrupt processing is executed with respect to a packet from at least one Ethernet port 30 among the Ethernet ports 30-1 to 30-3, and when a loss of a packet detected by the detecting unit 110 exceeds a threshold value that is set in advance, the interrupt processing to transition to the polling processing.

Specifically, the transitioning unit 120 causes, for example, processing with respect to a packet from one of the Ethernet ports 30, from which a loss of a packet, which exceeds the threshold value, is detected, to transition from the interrupt processing to the polling processing, and transmits a signal notifying that the polling processing is to be executed to the appliance coupled to the one of the Ethernet ports 30, Then, the transitioning unit 120 sets, to secure a predetermined period of time (for example, 1 second) representing a period of time for processing a packet, a polling cycle during the transition to a low cycle (for example, 100 msec) representing a first cycle. The transitioning unit 120 shortens, as the predetermined period of time (for example, 1 second) has passed, the polling cycle from the first cycle (for example, 100 msec) to a second cycle (for example, 50 msec). Then, the transitioning unit 120 shortens, in a stepwise manner, the second cycle until the second cycle reaches an upper limit value (for example, 1 msec) each time the predetermined period of time has passed. After that, the transitioning unit 120 causes, when a loss of a packet in the one of the Ethernet ports 30, in which transition to the polling processing has occurred, becomes equal to or less than the threshold value, the polling processing to return to the interrupt processing. In this case, the transitioning unit 120 may transmit a signal notifying that the polling processing ends to the appliance coupled to the one of the Ethernet ports 30.

By doing so, in the robot control device 1, the interrupt processing for reception in one of the Ethernet ports 30, in which Ethernet communication congestion has occurred, does not interfere with processing for another one of the Ethernet ports 30, pre venting communication with the teach pendant 2 and the network appliances 3-1 to 3-2 from being stopped. Thereby, the robot control device 1 is able to receive operation information of the teach pendant 2, properly process the received operation information, and transmit a reply to the teach pendant 2, making it possible to allow the teach pendant 2 to be constantly operated.

### <Transition Processing in Robot Control Device 1>

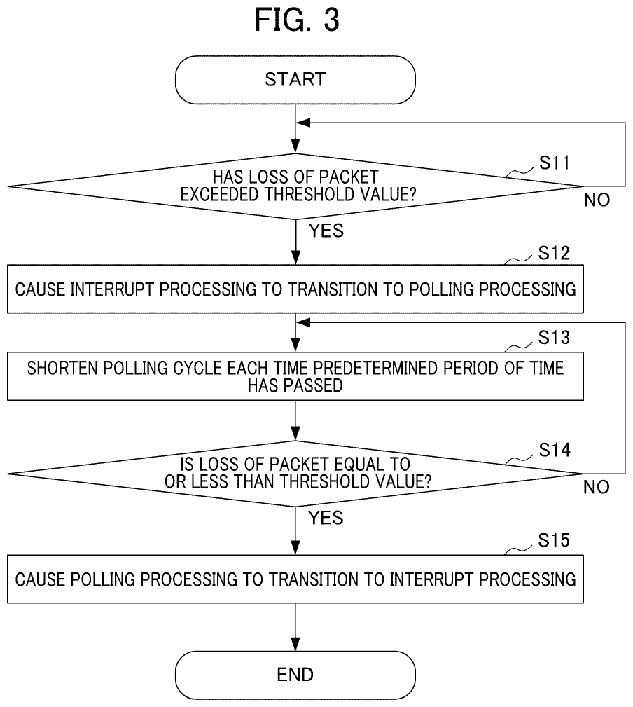

Next, a flow of transition processing in the robot control device 1 will now be described herein with reference to FIG. 3.

FIG. 3 is a flowchart illustrating the transition processing in the robot control device 1. The flow illustrated in here is executed each time packets are received in a predetermined amount from one of the Ethernet ports 30, and the interrupt processing is executed with respect to packets from the one of the Ethernet ports 30.

At Step S11, the detecting unit 110 determines whether or not a loss of a packet, which is detected in a certain period of time (for example, 500 msec or 1 second) in each of the Ethernet ports 30, exceeds the threshold value that is set in advance. When the loss of the packet exceeds the threshold value, the processing proceeds to Step S12. On the other hand, when the loss of the packet is equal to or less than the threshold value, the processing stands by at Step S11.

At Step S12, the transitioning unit 120 causes processing for one of the Ethernet ports 30, from which the loss of the packet, which exceeds the threshold value, is detected, to transition from the interrupt processing to the polling processing, and sets a polling cycle during the transition to the first cycle (for example, 100 msec).

At Step S13, the transitioning unit 120 shortens the polling cycle each time the predetermined period of time (for example, 1 second) has passed. Note that the transitioning unit 120 keeps, when the polling cycle has reached the upper limit value (for example, 1 msec), the polling cycle to the upper limit value.

At Step S14, the transitioning unit 120 determines whether or not a loss of a packet, which is detected by the detecting unit 110, becomes equal to or less than the threshold value. When the loss of the packet becomes equal to or less than the threshold value, the processing proceeds to Step S15. On the other hand, when the loss of the packet exceeds the threshold value, the processing returns to Step S13.

At Step S15, the transitioning unit 120 causes the polling processing to transition to the interrupt processing for the one of the Ethernet ports 30, in which the loss of the packet becomes equal to or less than the threshold value.

In the robot control device 1 according to the embodiment, as described above, processing for one of the Ethernet ports 30, in which a detected loss of a packet exceeds threshold value that is set in advance, is caused to transition from the interrupt processing the polling processing. Thereby, in the robot control device 1, it is possible to execute processing for another one of the Ethernet porta 30 without interference resulting from the interrupt processing for the one of the Ethernet ports 30, in which Ethernet communication congestion has occurred.

Furthermore, in the robot control device 1, interruption for reception in the one of the Ethernet ports 30, in which the congestion has occurred, does not interfere with processing for another one of the Ethernet ports 30, preventing communication with the teach pendant 2 and the network appliances 3-1 to 3-2 from being stopped. Thereby, the robot control device 1 is able to receive operation information of the teach pendant 2, properly process the received operation information, and transmit a reply to the teach pendant 2, making it possible to allow the teach pendant 2 to be constantly operated.

Although the embodiment has been described above, the robot control device 1 is not limited to those described in the above embodiment, but include modifications and improvements that fall within the scope of the present invention, as long as it is possible to achieve the object of the present invention.

Note that it is possible to achieve each of functions included in the robot control device 1 according to the embodiment through hardware, software, or a combination thereof. Note herein that achievement through software means achievement when a computer reads and executes programs.

It is possible to use a non-transitory computer readable medium that varies in type to store the programs, and to supply the programs to the computer. Examples of the non-transitory computer readable medium include tangible storage media that vary in type. Examples of the non-transitory computer readable medium include magnetic recording media (e.g., flexible disks, electromagnetic tape, and hard disk drives), magneto-optical recording media (e.g., magneto-optical discs), compact disc read only memories (CD-ROMs), compact disc-recordables (CD-Rs), compact disc-rewritables (CD-R/Ws), and semiconductor memories (e.g., mask ROME programmable ROMs (PROMs), erasable PROMs (EPROMs), flash ROMS, and random access memories (RAMs)). Furthermore, the programs may be supplied to the computer via a transitory computer readable medium that varies in type. Examples of the transitory computer readable medium include electric signals, optical signals, and electromagnetic waves. A transitory computer readable medium is able to supply the programs to the computer via wired communication channels such as electric wires and optical fibers or wireless communication channels.

Note that steps for describing programs to be recorded in a recording medium include not only processes sequentially executed in a chronological order, but also processes that may not necessarily be executed in a chronological order, but may be executed in parallel or separately.

In other words, it is possible that the robot control device according to the present disclosure take various types of embodiments having configurations described below.
(1) The robot control device 1 according to the present disclosure is a robot control device that is couplable to at least one appliance based on Ethernet, the robot control device including: the control unit 10; and the plurality of Ethernet ports 30, in which the control unit 10 includes: the detecting unit 110 configured to detect a state of a loss of a packet in at least one Ethernet port 30 among the plurality of Ethernet ports 30; and the transitioning unit 120 configured to cause, when the interrupt processing is executed with respect to a packet from at least one Ethernet port 30 among the plurality of Ethernet ports 30, and a loss of a packet exceeds a threshold value that is set in advance, the interrupt processing to transition to the polling processing.

With the robot control device 1, it is possible to execute processing for another Ethernet port without interference resulting from interrupt processing for an Ethernet port in which Ethernet communication congestion has occurred.
(2) In the robot control device 1 described in (1), the transitioning unit 120 may cause, when a loss of a packet, the loss being detected by the detecting unit 110, becomes equal to or less than the threshold value, the polling processing to transition to the interrupt processing.
(3) In the robot control device 1 described in (1) or (2), the control unit 10 may execute the interrupt processing when packets are received in a predetermined amount from one of the Ethernet ports, the one of the Ethernet ports being coupled to the control unit.
(4) In the robot control device 1 described in any one of (1) to (3), the polling processing may be executed at a first cycle during a predetermined period of time, and, after the predetermined period of time has passed, may be executed at a second cycle that is shorter than the first cycle.
(5) In the robot control device 1 described in (4), the second cycle may be shortened in a stepwise manner.
(6) In the robot control device 1 described in any one of (1) to (5), a loss of a packet may include a packet that could not be received from the appliance.
(7) In the robot control device 1 described in any one of (1) to (6), the appliance may be the teach pendant 2.

### EXPLANATION OF REFERENCE NUMERALS

1 Robot control device
2 Teach pendant
3-1 to 3-2 Network appliance
10, 210 Control unit
110 Detecting unit
120 Transitioning unit
20, 220 Storage unit
30-1 to 30-3, 230 Ethernet port
SYS Robot control system

1. A robot control device that is couplable to at least one appliance based on Ethernet, the robot control device comprising:
a control unit; and
a plurality of Ethernet ports,
wherein the control unit includes:
a detecting unit configured to detect a state of a loss of a packet in at least one Ethernet port among the plurality of Ethernet ports; and
a transitioning unit configured to cause, when interrupt processing is executed with respect to a packet from at least one Ethernet port among the plurality of Ethernet ports, and a loss of the packet exceeds a threshold value that is set in advance, the interrupt processing to transition to polling processing.

2. The robot control device according to claim 1, wherein the transitioning unit causes, when a loss of the packet, the loss being detected by the detecting unit, becomes equal to or less than the threshold value, the polling processing to transition to the interrupt processing.

3. The robot control device according to claim 1, wherein the control unit executes the interrupt processing when packets are received in a predetermined amount from one of the Ethernet ports, the one of the Ethernet ports being coupled to the control unit.

4. The robot control device according to claim 1, wherein the polling processing is executed at a first cycle during a predetermined period of time, and, after the predetermined period of time has passed, executed at a second cycle that is shorter than the first cycle.

5. The robot control device according to claim 4, wherein the second cycle is shortened in a stepwise manner.

6. The robot control device according to claim 1, wherein a loss of the packet includes a packet that could not be received from the appliance.

7. The robot control device according to claim 1, wherein the appliance is a teach pendant.
